(19) United States
(12) Patent Application Publication
(10) Pub. No.: US 2011/0261474 A1
(43) Pub. Date: Oct. 27, 2011

(54) MIRROR PLATE AND REARVIEW MIRROR USING SAME

(76) Inventor: Hui-Li LIN, Tainan City (TW)

(21) Appl. No.: 12/783,082

(22) Filed: May 19, 2010

(30) Foreign Application Priority Data
Apr. 22, 2010 (TW) 99112737

(51) Int. Cl. G02B 7/182

(52) U.S. Cl. 359/871

(57) ABSTRACT

A mirror plate for rearview mirror is disclosed to include a primary vision block having opposing front and back sides and a reflective layer located on the front or back side for reflecting a major rear field of view, and one or a number of supplementary vision blocks abutted against a part or the whole area of the border of the primary vision block, each supplementary vision block having opposing front and back sides and multiple reflective layers continuously arranged on the front or back side for reflecting a supplementary rear field of view around the major rear field of view. The invention also provides a rearview mirror using the mirror plate.

### BACKGROUND OF THE INVENTION

1. Field of the Invention

The present invention relates to rearview mirror technology and more particularly, to a mirror plate for rearview mirror that provides a wide rearview angle. The invention relates also to a rearview mirror using the mirror plate.

2. Description of the Related Art

In order to widen the rearview angle of a mirror plate for rearview mirror, the outer lateral side of the primary vision block may be curved and slopped. Thus, the viewing angle of the outer lateral side or lower side is widened. However, a wide-angle mirror plate made according to this method has the drawback that the size of the longitudinal depth is greater than the thickness of the mirror plate, limiting the size arrangement and shape design.

Further, it is not easy to curve or slope the outer lateral side of the primary vision block of a mirror plate for rearview mirror, or to attach a supplementary vision block to the primary vision block.

Therefore, it is desirable to provide a mirror plate for rearview mirror that eliminates the aforesaid problems.

### SUMMARY OF THE INVENTION

The present invention has been accomplished under the circumstances in view. It is the main object of the present invention to provide a mirror plate for rearview mirror and a rearview mirror using the mirror plate, which minimizes the longitudinal depth of the whole mirror plate of the rearview mirror, provides an enhanced viewing angle, and facilitates mirror plate fabrication and installation.

To achieve this and other objects of the present invention, a mirror plate for rearview mirror comprises a primary vision block having opposing front and back sides and a reflective layer located on the front or back side for reflecting a major rear field of view, and one or a number of supplementary vision blocks abutted against a part or the whole area of the border of the primary vision block. Each supplementary vision block has opposing front and back sides, and multiple reflective layers continuously arranged on the front or back side for reflecting a supplementary rear field of view around the major rear field of view.

The invention also provides a rearview mirror using the mirror plate.

Other and further benefits, advantages and features of the present invention will be understood by reference to the following specification in conjunction with the accompanying drawings, in which like reference signs denote like elements of the structure.

### BRIEF DESCRIPTION OF THE DRAWINGS

FIG. 1 is schematic drawing, showing a status of use of a mirror plate in a rearview mirror in accordance with a first embodiment of the present invention.

FIG. 2 is a front view of the mirror plate in accordance with the first embodiment of the present invention.

FIG. 3 is a top view of a part of the mirror plate in accordance with the first embodiment of the present invention.

FIG. 4 is a schematic sampling view of the mirror plate in accordance with the first embodiment of the present invention.

FIG. 5 is a right side view of a part of the mirror plate in accordance with the first embodiment of the present invention.

FIG. 6 is a schematic assembly view of a rearview mirror in accordance with a second embodiment of the present invention.

FIG. 7 is a schematic assembly view of a rearview mirror in accordance with a third embodiment of the present invention.

FIG. 8 is a top view of a part of a rearview mirror in accordance with a fourth embodiment of the present invention.

### DETAILED DESCRIPTION OF THE INVENTION

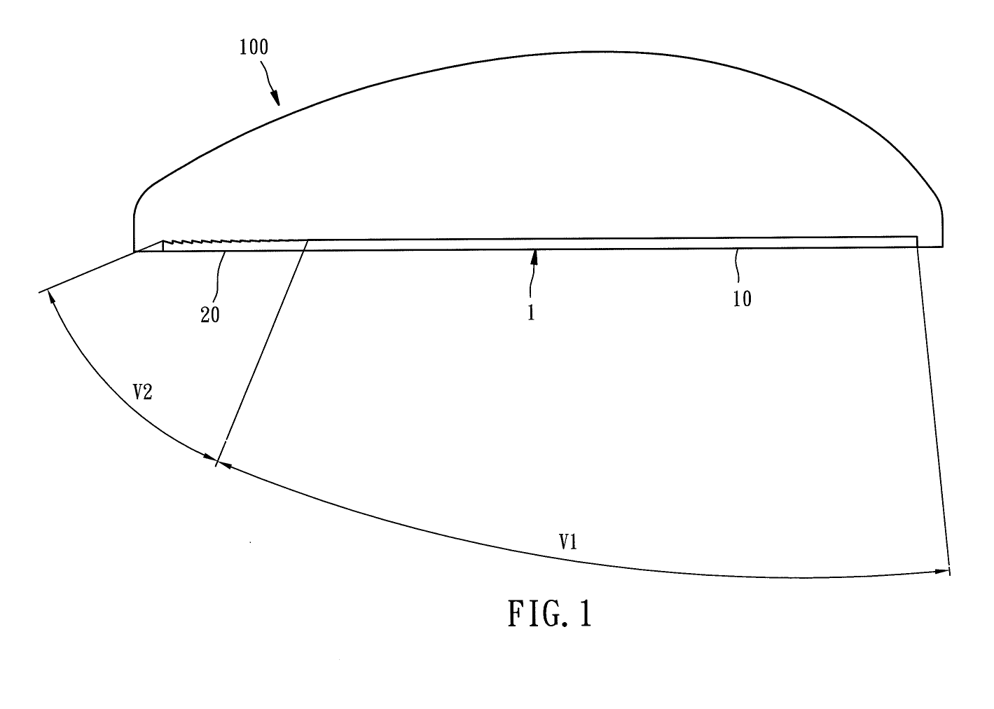

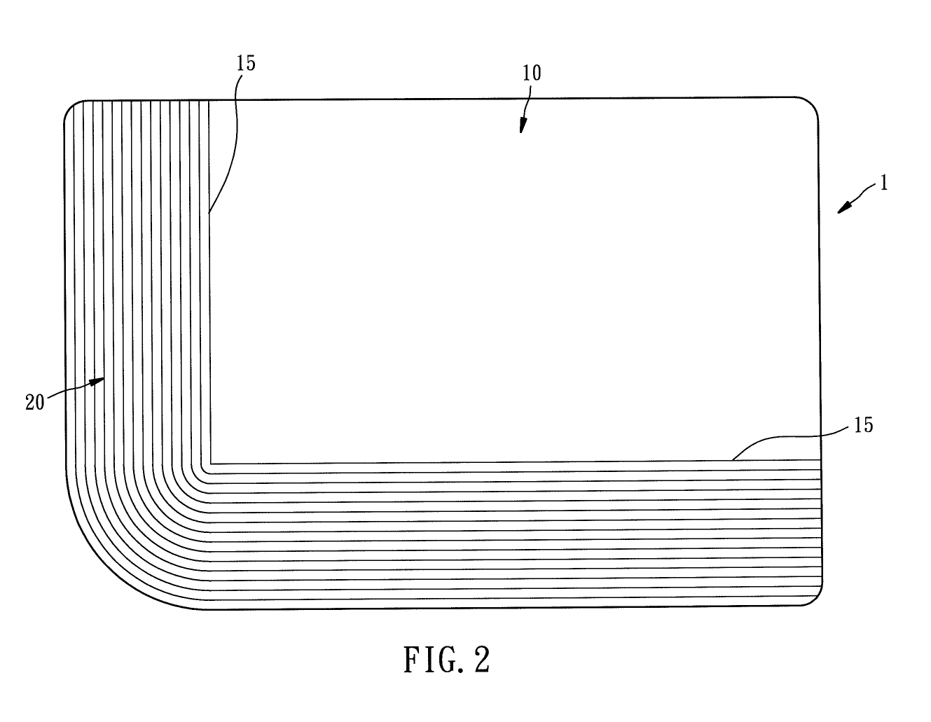

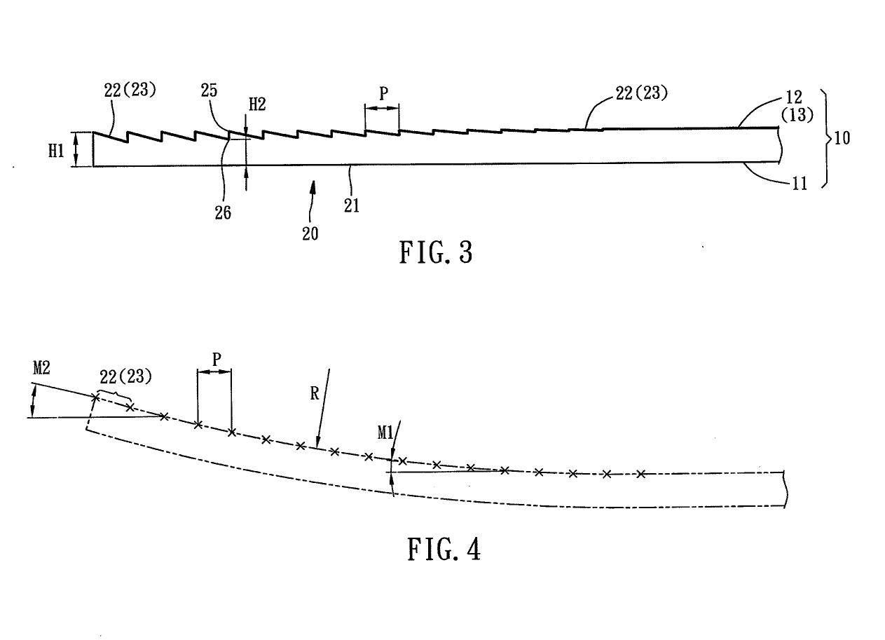

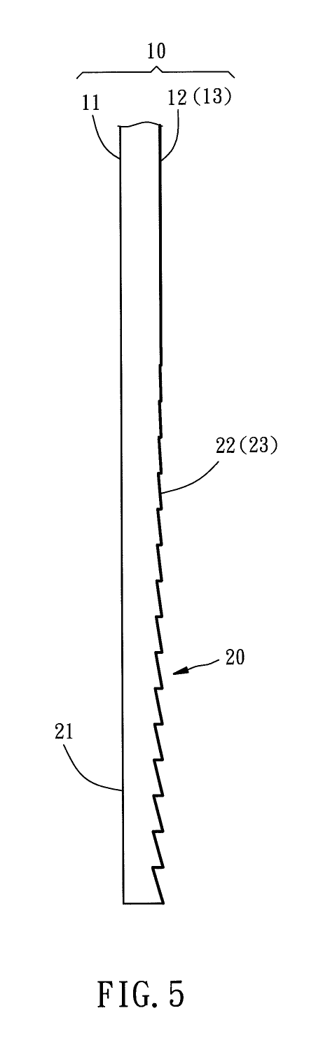

Referring to FIGS. 1˜5, a mirror plate 1 in accordance with a first embodiment of the present invention is shown used in a rearview mirror 100.

The mirror plate 1 comprises a primary vision block 10 and a supplementary vision block 20. The primary vision block 10 comprises a front side 11, a back side 12, at least one reflective layer 13 located on the back side 12 for reflecting a major rear field of view V1, a border 15, and a thickness T1 defined between the front side 11 and the back side 12,

The supplementary vision block 20 is abutted against at least one part or the entire of the border 15 of the primary vision block 10. According to this embodiment, the supplementary vision block 20 is located on the left lateral, lower side and left lower side of the rearview mirror 100. The primary vision block 10 and the supplementary vision block 20 are formed in integrity. The supplementary vision block 20 comprises a front side 21, a back side 22, a plurality of reflective layers 23 continuously arranged on the back side 22 for reflecting a supplementary rear field of view V2 around the major rear field of view V1.

The reflective layers 23 of the supplementary vision block 20 are continuously arranged into a wavelike configuration having multiple peaks 25 and multiple troughs 26. According to this embodiment, the reflective layers 23 are attached to the back side 22 of the supplementary vision block 20, fitting the shape of the back side 22. With respect to the sampling of the design pattern of the reflective layers 23, please refer to FIG. 4. As shown in FIG. 4, the reflective layers 23 of the supplementary vision block 20 have the same radius of curvature R that is transversely divided into multiple pitches P where the slope M2 of the outer pitch is greater than the slope M1 at the inner pitch so that a wide field of rear side view is obtained. It is to be understood that the pitches P can have the same slope that is greater than the slope of the back side 12 of the primary vision block 10 so that a predetermined field of rear side view can be obtained.

Subject to the application of the present invention, the slope or radius of curvature of every reflective layer 23 of the supplementary vision block 20 is greater than the slope or radius of curvature of the primary vision block 10.

Further, the distances of normal lines H1 between the peaks 25 of the reflective layers 23 of the supplementary vision block 20 and the front side 21 of the supplementary vision block 20 may be within the range of the thickness T1 of the primary vision block 10, or slightly greater than the thickness T1 of the primary vision block 10. The distances of normal lines H2 between the troughs 26 of the reflective layers 23 of the supplementary vision block 20 and the front side 21 of the supplementary vision block 20 must be within the range of the thickness T1 of the primary vision block 10.

Further, the front side 21 of the supplementary vision block 20 and the front side 11 of the primary vision block 10 are the same, namely same thickness and same plane.

The use and principle of the invention are explained thereinafter:

When viewing the mirror plate 1 of the rearview mirror 100, the viewer's eyes can simultaneously see the primary vision block 10 and the supplementary vision block 20. At this time, the primary vision block 10 reflects the image of the major rear field of view V1 to the viewer's eyes, and the supplementary vision block 20 reflects the image of the supplementary rear field of view V2 around the major rear field of view V1 to the viewer's eyes. Thus, the invention reflects the image of the supplementary rear field of view V2 around the left side, left lower side and lower side of the rearview mirror 100, as shown in FIG. 1.

That is, the image of the supplementary rear field of view V2 around the left side, left lower side and lower side of the rearview mirror 100 visible by the user is wider than the image of the field of view reflected by an equal size of mirror plate that have the same shape and slope relative to the primary vision block 10. This is the improvement the invention provides.

Further, the supplementary vision block 20 can be directly molded by a mold, or made by means of laser machining or polishing techniques. All these methods can be selectively employed to make the mirror plate conveniently and rapidly.

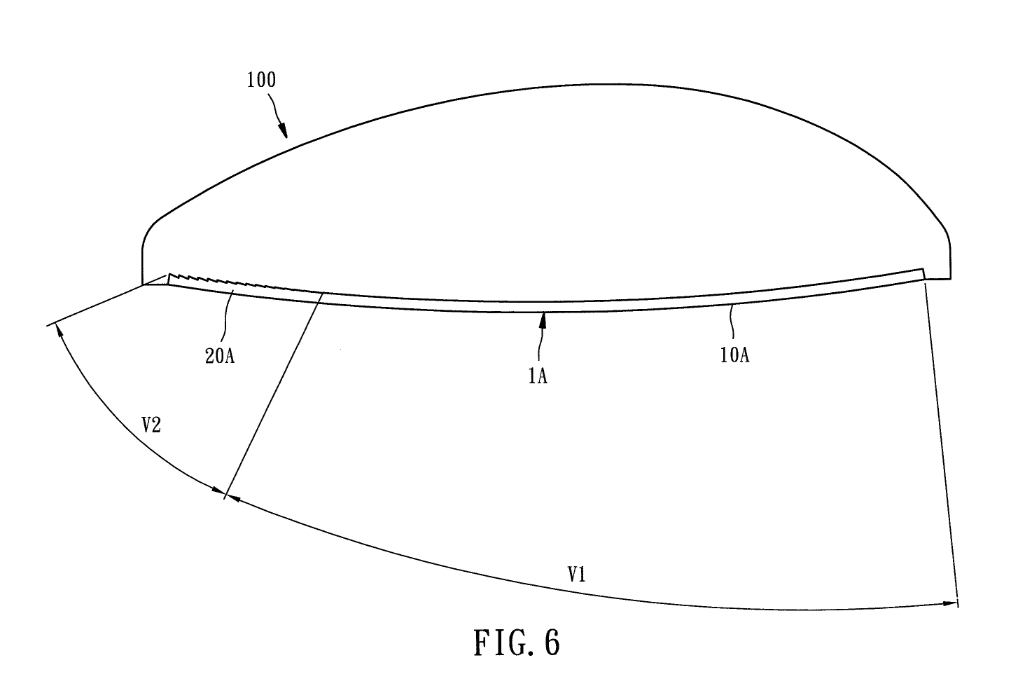

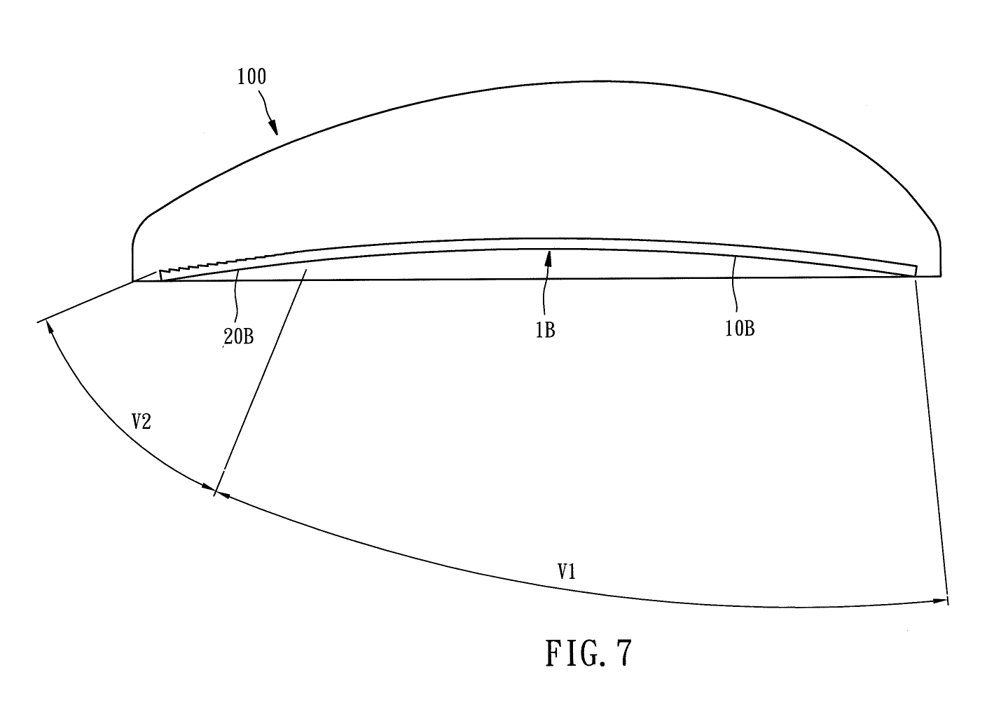

Except the aforesaid embodiment, the mirror plate can be prepared in many other forms. FIG. 6 shows a second embodiment of the present invention. According to this embodiment, the primary vision block 10A of the mirror plate 1A curves outwards; the supplementary vision block 20A also curves outwards. FIG. 7 shows a third embodiment of the present invention. According to this embodiment, the primary vision block 10B of the mirror plate 1B curves inwards; the supplementary vision block 20B also curves inwards. It is to be understood that either the primary vision block or the supplementary vision block can have a planar, convex or concave structure.

Further, it is also to be understood that the slope or radius of curvature of each reflective layer of the supplementary vision block can be equal or smaller than the slope or radius of curvature of the primary vision block.

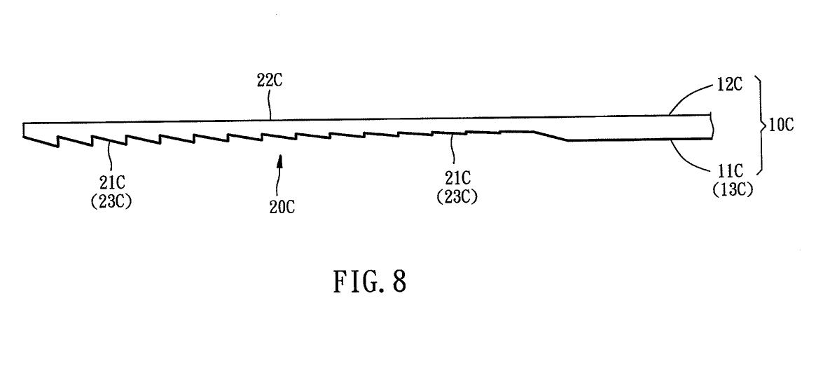

FIG. 8 shows a fourth embodiment of the present invention. According to this embodiment, the reflective layer 13C of the primary vision block 10C of the mirror plate 1C is located on the front side 11C but not on the back side 12C. Similarly, the continuously arranged reflective layers 23C of the supplementary vision block 20C can also be located on the front side 21C but not on the back side 22C.

Other changes may be employed. For example, the slopes or radius of curvature of the reflective layers of the supplementary vision block may increase gradually in one direction; the primary vision block and the supplementary vision block may be separately prepared and then bonded or assembled together.

Further, the supplementary vision block can be located on one or two of the left, right, upper, lower, left upper, left lower, right upper and right lower sides of the rearview mirror subject to the location of the field of view to be enhanced.

Further, the reflective layers of the supplementary vision block on the left upper, left lower, right upper and right lower sides of the rearview mirror can be connected together in a straight line or any of a variety of other geometric lines instead of the aforesaid smoothly arched profile, i.e., the supplementary vision block on either of the left upper, left lower, right upper and right lower sides of the rearview mirror can be shaped like a arched line, straight line or any of a variety of other geometric lines, achieving the same expected effects of the present invention.

In conclusion, the structural design of the continuously arranged reflective layers on the front side or back side of the supplementary vision block minimizes the longitudinal depth of the whole mirror plate of the rearview mirror while providing enhanced viewing angle. Further, this design facilitates mirror plate fabrication and installation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mirror plate for rearview mirror, comprising:
a primary vision block, said primary vision block comprising opposing front and back sides, at least one reflective layer located on one of the opposing front and back sides for reflecting a major rear field of view, and a border; and
at least one supplementary vision block abutted against at least one part of the border of said primary vision block, each said supplementary vision block comprising opposing front and back sides and a plurality of reflective layers continuously arranged on one of the opposing front and back sides for reflecting a supplementary rear field of view around said major rear field of view.

2. The mirror plate as claimed in claim 1, wherein the reflective layers of each said supplementary vision block are continuously arranged into a wavelike configuration having multiple peaks and multiple troughs.

3. The mirror plate as claimed in claim 2, wherein the distances of normal lines between the peaks of the reflective layers of said supplementary vision block and the front side or back side of said supplementary vision block are within the range of the thickness of said primary vision block.

4. The mirror plate as claimed in claim 2, wherein the distances of normal lines between the troughs of the reflective layers of said supplementary vision block and the front side or back side of said supplementary vision block are within the range of the thickness of said primary vision block.

5. The mirror plate as claimed in claim 2, wherein the reflective layers of each said supplementary vision block have the same slope, the same radius of curvature, gradually increasing slope, or gradually reducing radius of curvature.

6. The mirror plate as claimed in claim 5, wherein the reflective layers of each said supplementary vision block are attached to the front or back side of the respective supplementary vision block subject to the shape of the respective supplementary vision block.

7. The mirror plate as claimed in claim 2, wherein said primary vision block and said at least one supplementary vision block are respectively made in one of planar design, convex design and concave design.

8. The mirror plate as claimed in claim 7, wherein the reflective layers of each said supplementary vision block are attached to the front or back side of the respective supplementary vision block subject to the shape of the respective supplementary vision block.

9. The mirror plate as claimed in claim 2, wherein said primary vision block and said at least one supplementary vision block are made in integrity, or separately prepared and then assembled together.

10. The mirror plate as claimed in claim 2, wherein the reflective layers of each said supplementary vision block are attached to the front or back side of the respective supplementary vision block subject to the shape of the respective supplementary vision block.

11. A rearview mirror having installed therein a mirror plate as claimed in claim 2.

12. The rearview mirror as claimed in claim 11, wherein said at least one supplementary vision block is located on at least one of left, right, upper, lower, left upper, left lower, right upper and right lower sides of the rearview mirror.

13. The mirror plate as claimed in claim 1, wherein the reflective layers of each said supplementary vision block have the same slope, the same radius of curvature, gradually increasing slope, or gradually reducing radius of curvature.

14. The mirror plate as claimed in claim 13, wherein the reflective layers of each said supplementary vision block are attached to the front or back side of the respective supplementary vision block subject to the shape of the respective supplementary vision block.

15. The mirror plate as claimed in claim 1, wherein said primary vision block and said at least one supplementary vision block are respectively made in one of planar design, convex design and concave design.

16. The mirror plate as claimed in claim 15, wherein the reflective layers of each said supplementary vision block are attached to the front or back side of the respective supplementary vision block subject to the shape of the respective supplementary vision block.

17. The mirror plate as claimed in claim 1, wherein said primary vision block and said at least one supplementary vision block are made in integrity, or separately prepared and then assembled together.

18. The mirror plate as claimed in claim 1, wherein the reflective layers of each said supplementary vision block are attached to the front or back side of the respective supplementary vision block subject to the shape of the respective supplementary vision block.

19. A rearview mirror having installed therein a mirror plate as claimed in claim 1.

20. The rearview mirror as claimed in claim 19, wherein said at least one supplementary vision block is located on at least one of left, right, upper, lower, left upper, left lower, right upper and right lower sides of the rearview mirror.
